(19) United States
(12) Patent Application Publication
(10) Pub. No.: US 2026/0310706 A1
(43) Pub. Date: Oct. 8, 2026

(54) MATERIAL RECOMMENDATION DEVICE, MATERIAL RECOMMENDATION METHOD, AND RECORDING MEDIUM

(71) Applicant: DIC Corporation, Tokyo (JP)

(72) Inventors: Kenji Nakamura, Chiba (JP); Yuki Wada, Tokyo (JP)

(73) Assignee: DIC Corporation, Tokyo (JP)

(21) Appl. No.: 19/108,281

(22) PCT Filed: Sep. 26, 2023
(86) PCT No.: PCT/JP2023/034824

§ 371 Date: Mar. 3, 2025

(30) Foreign Application Priority Data
Sep. 26, 2022 (JP) 2022-152385

(51) Int. Cl. G06F 16/335; G06F 16/353

(52) U.S. Cl. CPC G06F 16/335; G06F 16/353

(57) ABSTRACT

A material recommendation device includes: an input device that receives an input of a product type and an emotion word; and a hardware processor that: based on material parameter information that associates a material used in a product belonging to the product type with a value of a sense parameter indicating a degree of a human sense for the material, extracts a value of a sense parameter for each material corresponding to the input product type; based on emotion word parameter information that associates the emotion word with the value of the sense parameter, extracts a value of a sense parameter corresponding to the input emotion word; and based on the extracted value of the sense parameter for each material and the extracted value of the sense parameter corresponding to the emotion word, determines the material to be recommended for the input emotion word.

### CROSS-REFERENCE TO RELATED APPLICATIONS

The present application claims priority from Japanese Patent Application No. 2022-152385, filed on Sep. 26, 2022, the entire contents of which are incorporated herein by reference.

### BACKGROUND

### Technical Field

The present invention relates to a material recommendation device, a material recommendation method, and a recording medium storing instructions.

### Description of Related Art

As an index used as an evaluation standard when a user selects a particular product, for example, characteristics and performance of a material used for a product are exemplified. In addition, an impression of the user, such as how the material is felt by five senses (visual sense, tactile sense, auditory sense, taste sense, and olfactory sense) and how the material is compromised on the sensitivity, is also one of important indices used as an evaluation standard when the user selects a product.

In the related art, it is difficult to present a material that exhibits a sense desired by a user with high accuracy. In order to recommend a material corresponding to the sense desired by the user, for example, a person in charge who recommends the material needs to perform sufficient hearing or the like for the user. However, in this case, whether the material that exhibits the sense desired by the user is appropriately recommended largely depends on the sense of the person in charge. This is because, for example, even when the user requests a “comfortable” material, the comfort considered by the user does not necessarily coincide with the comfort considered by the person in charge.

In order to solve such a problem, for example, an approximate tactile material recommendation system described in PTL 1 holds in advance a parameter value indicating a correspondence between a term (onomatopoeia) expressing a tactile sense and a physical characteristic of a surface of a material, and automatically presents a material recommended for the input onomatopoeia based on the parameter value.

### PATENT LITERATURE

PTL 1: JP4469908B

The approximate tactile material recommendation system described in PTL 1 is a system that corresponds to only an input by the onomatopoeia representing the tactile sense. However, actually, an impression received by the user from the material is not necessarily an impression obtained by the tactile sense. The impression received by the user from the material may include an impression obtained by a plurality of senses among the five senses or all the senses.

In addition, when the user expresses an impression received from a material in words, the impression is not limited to an onomatopoeia (for example, “smooth” or “slippery”) that simply expresses an impression obtained by five senses in a pseudo manner. The user often expresses an impression received from a material by a word expressing an emotion. The words expressing emotions referred to here are adjectives or the like used to quantify person senses in general sensory evaluations. Examples of such an adjective include “favorite”, “unique”, “comfortable”, and “having high-grade feeling”, which are not limited to specific senses among the five senses. As described above, in the related art, there is a problem that it is difficult to recommend a material according to an emotion of a person.

### SUMMARY

One or more embodiments of the invention provide a material recommendation device, a material recommendation method, and a recording medium storing instructions capable of recommending a material according to an emotion of a person.

The content of the disclosure includes the following embodiments.

[1] A material recommendation device includes: an input device that receives an input of a product type and an emotion word expressing an emotion of a user; and a hardware processor that: extracts, based on material parameter information that associates a material used in a product belonging to the product type with a value of a sense parameter indicating a degree of a human sense for the material, a value of a sense parameter for each material corresponding to the product type input to the input device; extracts, based on emotion word parameter information that associates the emotion word with the value of the sense parameter, a value of a sense parameter corresponding to the emotion word input to the input device; and identifies, based on the value of the sense parameter for each material that has been extracted and the value of the sense parameter corresponding to the emotion word that has been extracted, the material to be recommended for the emotion word input to the input device, and presents the material that has been identified to the user.

[2] In the material recommendation device according to [1], the emotion word is a phrase classified into an evaluation factor or an activity factor among factors of an evaluation-potency-activity (EPA) structure defined in an impression evaluation according to a semantic differential (SD) method.

[3] In the material recommendation device according to [1] or [2], the hardware processor corrects the value of the sense parameter using a coefficient in consideration of a cross modal effect in which impressions received by a plurality of types of senses are related to each other.

[4] In the material recommendation device according to [3], the coefficient is set to a value that is different according to an order in which the impressions are received by the plurality of types of senses, and the hardware processor acquires information indicating the order and corrects the value using the coefficient corresponding to the acquired order.

[5] In the material recommendation device according to [4], the coefficient used for correcting the value of the sense parameter for each material is set to a value of 1 for the sense received first, is set to a value larger than 0 and smaller than 1 for the sense received later, and is set to 0 for other senses.

[6] In the material recommendation device according to [4] or [5], the coefficient used for correcting the value of the sense parameter of the emotion word is set to a value of 1 for the sense in which the cross modal effect occurs, and is set to a value of 0 for the sense in which the cross modal effect does not occur.

[7] In the material recommendation device according to any of [1] to [6], the sense includes five senses or a sense obtained by subdividing the five senses.

[8] A material recommendation method for a material recommendation device comprising an input device includes: receiving, by the input device, an input of a product type and an emotion word expressing an emotion of a user; extracting, based on material parameter information that associates a material used in a product belonging to the product type with a value of a sense parameter indicating a degree of a human sense for the material, a value of a sense parameter for each material corresponding to the product type input to the input device; extracting, based on emotion word parameter information that associates the emotion word with the value of the sense parameter, a value of a sense parameter corresponding to the emotion word input to the input device; and identifying, based on the value of the sense parameter for each material that has been extracted and the value of the sense parameter corresponding to the emotion word that has been extracted, the material to be recommended for the emotion word input to the input device, and presenting the material that has been identified to the user.

[9] A non-transitory computer readable recording medium stores instructions causing a material recommendation device comprising an input device to execute: receiving, by the input device, an input of a product type and an emotion word expressing an emotion of a user; extracting, based on material parameter information that associates a material used in a product belonging to the product type with a value of a sense parameter indicating a degree of a human sense for the material, a value of a sense parameter for each material corresponding to the product type input to the input device; extracting, based on emotion word parameter information that associates the emotion word with the value of the sense parameter, a value of a sense parameter corresponding to the emotion word input to the input device; and identifying, based on the value of the sense parameter for each material that has been extracted and the value of the sense parameter corresponding to the emotion word that has been extracted, the material to be recommended for the emotion word input to the input device, and presenting the material that has been identified to the user.

According to one or more embodiments of the invention, it is possible to recommend a material according to an emotion of a person.

### BRIEF DESCRIPTION OF DRAWINGS

FIG. 1 is a block diagram showing a functional configuration of a material recommendation device 100 according to one or more embodiments of the disclosure.

FIG. 2 is a diagram showing an example of emotion words input to the material recommendation device 100 according to one or more embodiments of the disclosure.

FIG. 3 is a diagram showing an example of five sense parameters used in a material recommendation device 100 according to one or more embodiments of the disclosure.

FIG. 4 is a diagram showing an example of material parameter information 111 stored in a parameter information storage unit 110 of the material recommendation device 100 according to one or more embodiments of the disclosure.

FIG. 5 is a diagram showing an example of emotion word parameter information 112 stored in the parameter information storage unit 110 of the material recommendation device 100 according to one or more embodiments of the disclosure.

FIG. 6 is a diagram showing an example of modal correction information 113 stored in the parameter information storage unit 110 of the material recommendation device 100 according to one or more embodiments of the disclosure.

FIG. 7 is a diagram showing an example of the modal correction information 113 stored in the parameter information storage unit 110 of the material recommendation device 100 according to one or more embodiments of the disclosure.

FIG. 8 is a flowchart showing an operation of the material recommendation device 100 according to one or more embodiments of the disclosure.

FIG. 9 is a diagram showing an example of correction processing of a value of a material parameter performed by a modal correction unit 133 of the material recommendation device 100 according to one or more embodiments of the disclosure.

FIG. 10 is a diagram showing an example of correction processing of a value of an emotion word parameter performed by the modal correction unit 133 of the material recommendation device 100 according to one or more embodiments of the disclosure.

FIG. 11 is a diagram showing an example of calculation processing of a distance between coordinates performed by a recommendation material determination unit 134 of the material recommendation device 100 according to one or more embodiments of the disclosure.

FIG. 12 is a diagram showing an example of information output by an output unit 140 of the material recommendation device 100 according to one or more embodiments of the disclosure.

FIG. 13 is a diagram showing another example of the information output by the output unit 140 of the material recommendation device 100 according to one or more embodiments of the disclosure.

### DETAILED DESCRIPTION OF EMBODIMENTS

Hereinafter, embodiments of the disclosure will be described with reference to the drawings.

### Configuration of Material Recommendation Device

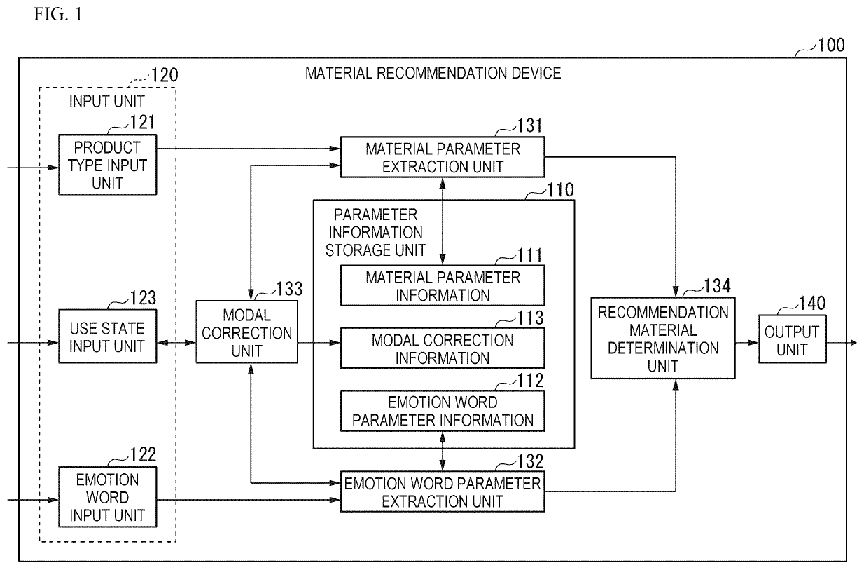

Hereinafter, a configuration of a material recommendation device 100 according to one or more embodiments will be described. FIG. 1 is a block diagram showing a functional configuration of the material recommendation device 100 according to one or more embodiments of the disclosure.

The material recommendation device 100 is an information processing device implemented using, for example, a general-purpose computer. The material recommendation device 100 receives an input of a word that expresses a sense desired by a user for a material used in a product, that is, a word that expresses an emotion of the user (hereinafter, referred to as an “emotion word”). The material recommendation device 100 determines at least one recommended material based on the input emotion word, and outputs information indicating the determined material.

FIG. 1 is a block diagram showing a functional configuration of the material recommendation device 100 according to one or more embodiments of the disclosure. As shown in FIG. 1, the material recommendation device 100 includes a parameter information storage unit 110, an input unit 120, a material parameter extraction unit 131, an emotion word parameter extraction unit 132, a modal correction unit 133, a recommendation material determination unit 134, and an output unit 140.

The parameter information storage unit 110 is implemented using a computer-readable storage medium. The computer-readable storage medium referred to here is, for example, a magnetic hard disk device or a semi-conductor storage device. The parameter information storage unit 110 stores in advance various types of parameter information used to determine a recommended material. As shown in FIG. 1, the parameter information storage unit 110 stores at least material parameter information 111, emotion word parameter information 112, and modal correction information 113. Details of each type of parameter information will be described later.

The input unit 120 is implemented using an input device that receives an input operation by the user. Examples of the input device referred to here include a keyboard, a mouse, a touch panel, and an input button. As shown in FIG. 1, the input unit 120 includes a product type input unit 121, an emotion word input unit 122, and a use state input unit 123.

The product type input unit 121 acquires information (hereinafter, referred to as “product type information”) indicating the product type input by the user. The product type input unit 121 outputs the acquired product type information to the material parameter extraction unit 131. The product type information referred to here is information indicating the type of the material used for the product, such as “food packaging material”, “house building material”, and “synthetic leather for bag”.

The emotion word input unit 122 acquires information (hereinafter, simply referred to as an “emotion word”) indicating an emotion word input by the user. The emotion word input unit 122 outputs the acquired emotion word to the emotion word parameter extraction unit 132. The emotion word referred to here is a phrase such as an adjective used to quantify a person sense (or human sense) in a general sensory evaluation. In such an adjective, there are phrases that are not limited to specific senses among the five senses, such as “favorite”, “unique”, “comfortable”, and “having high-grade feeling”.

Note that, in the general sensory evaluation, when an emotion of a person is quantified and evaluated, an evaluation based on a semantic differential (SD) method is often used. The SD method is a method for measuring an impression (sensitivity) of a person for an object by using a pair of adjectives having opposite meanings to each other, and performing numerical value evaluation. A feature of the SD method is that an impression structure can be expressed by a small number of factors, and for example, in the SD method, a structure including three basic factors interpreted as an evaluation factor, an activity factor, and a potency factor is found. This structure is called an evaluation-potency-activity (EPA) structure.

The evaluation factor is expressed by a pair of adjectives representing a comprehensive evaluation related to a value of the object, such as “favorite-dislike”, “good-bad”, and “beautiful ugly”. In addition, the evaluation factor is different depending on the type (form, color, sound, or the like) of the object to be evaluated, but is also implemented by a pair of adjectives expressed for a property of the object, such as “stable-unstable”, “clear-cloudy”, and “warm-cold”.

The activity factor and the potency factor are both implemented by expressions related to the properties of the object. The activity factor is expressed by a pair of adjectives such as “noisy quiet”, “dynamic—static”, and “bright—sober”. The potency factor is expressed by a pair of adjectives such as “hard—soft”, “sharp—dull”, and “tightened—loose”.

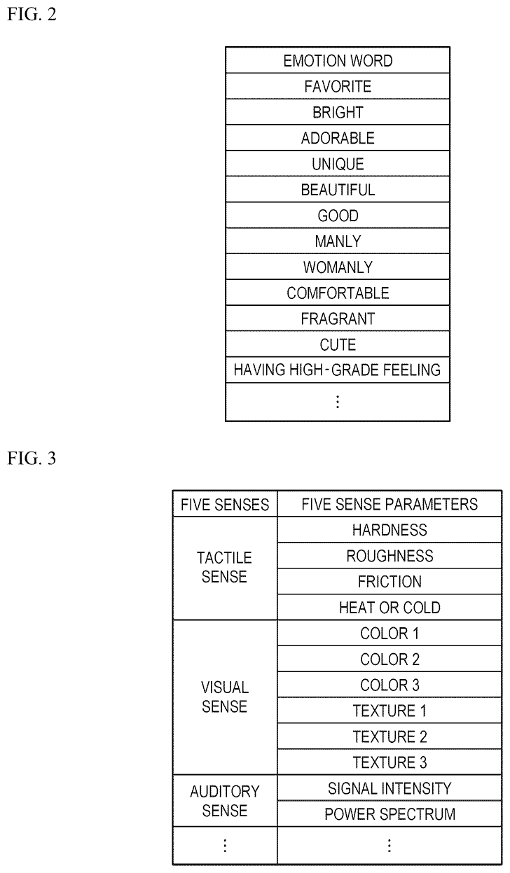

FIG. 2 is a diagram showing an example of emotion words input to the material recommendation device 100 according to one or more embodiments of the disclosure. Among the three basic factors described above, the evaluation factor and the activity factor include a large number of adjectives directly representing emotions of the person. In one or more embodiments, as an example, a phrase classified into the evaluation factor and the activity factor, among the factors of the EPA structure defined in the impression evaluation by the SD method, is defined as an emotion word. Note that, the pair of adjectives is not defined as an emotion word, but both of the pair of adjectives are defined separately as one emotion word.

The use state input unit 123 acquires information indicating a use state of a product (hereinafter, referred to as “use state information”) input by the user. The use state input unit 123 outputs the acquired use state information to the modal correction unit 133.

The use state information referred to here is information that can identify a state in which, which sense of the five senses the user uses to receive an impression when receiving the impression from the product. In addition, the use state information is information that can identify a state in which, what order the user depends to receive impressions by senses when receiving the impressions by a plurality of senses of the five senses. For example, the use state information is information that can identify whether is in a state in which the user first views the product and then touches the product or in a state in which the user first touches the product and then views the product when the user receives impressions by two senses of the visual sense and the tactile sense among the five senses.

The material parameter extraction unit 131, the emotion word parameter extraction unit 132, the modal correction unit 133, and the recommendation material determination unit 134 are functional units implemented by a hardware processor such as a central processing unit (CPU) reading and executing instructions such as a program stored in advance in a storage unit (not shown). Note that, the storage unit and the parameter information storage unit 110 may be implemented using the same storage medium.

The material parameter extraction unit 131 acquires the product type information output from the product type input unit 121. In addition, the material parameter extraction unit 131 refers to the material parameter information 111 stored in the parameter information storage unit 110. The material parameter extraction unit 131 extracts, from the material parameter information 111, a value of a material parameter associated with a product type corresponding to the acquired product type information.

The material parameter information 111 is information indicating a degree of association between a material and a five sense parameter. In addition, the five sense parameter referred to here is implemented by an item indicating five senses or an item indicating a further subdivided sense of each of the five senses. Note that, in one or more embodiments, it is assumed that the five sense parameter is implemented by an item indicating a further subdivided sense of each of the five senses.

FIG. 3 is a diagram showing an example of five sense parameters used in the material recommendation device 100 according to one or more embodiments of the disclosure. As shown in FIG. 3, the tactile sense is further classified into five sense parameters such as “hardness”, “roughness”, “friction”, and “heat or cold”. In addition, the visual sense is further classified into five sense parameters such as “color 1”, “color 2”, “color 3”, “texture 1”, “texture 2”, and “texture 3”.

Note that, it is found that the tactile sense can be classified into four elements of hardness, roughness, friction, and heat or cold. In addition, specifically, for example, values of an average roughness Ra and a maximum height Rz defined by the standard (JIS B 0601) may be used as the five sense parameter of “roughness” of the tactile sense. Alternatively, parameters and values obtained by subjecting the average roughness Ra, the maximum height Rz, or the like to main component analysis or factor analysis to reduce dimensions may be used. In addition, for example, a value of the Young's modulus calculated based on a pushing force and displacement may be used as the five sense parameter of “hardness” of the tactile sense. In addition, for example, a value of a dynamic friction coefficient when a material is touched may be used as the five sense parameter of the “friction” of the tactile sense.

Note that, when the material recommendation device 100 is made to correspond to various materials, it is desirable to acquire a parameter value evaluated uniformly for all materials using, for example, a wearable device in relation to the tactile sense. By wearing the wearable device on a hand of a person and actually touching the material, it is possible to uniformly measure the friction, the hardness, or the like.

Note that, in terms of the visual sense, “color 1”, “color 2”, and “color 3” are included in the five sense parameters of the visual sense shown in FIG. 3, and it is generally found that colors can be expressed by three variables such as L*a*b* or L*C*H. For example, three variables may be respectively used as the five sense parameters of “color 1”, “color 2”, and “color 3”. Note that, the material recommendation device 100 may use three variables in any color space, but it is necessary to evaluate all the materials using three variables in the same color space.

Note that, it is not found that the visual sense can be clearly classified into finite elements like the tactile sense. However, in recent years, it was found that elements of color and texture are important elements that affect a visual sense impression of a person. Here, the texture is physical property information related to a reflectance as represented by a bidirectional reflectance distribution function BRDF. The bidirectional reflectance distribution function (BRDF) is an angular distribution characteristic of reflected light when light is incident from a specific angle. Generally, in computer graphics (CG), the texture of the material is reconstructed by rendering using parameters of the BRDF. Of course, regarding these parameters, a parameter and a value obtained by subjecting main component analysis or factor analysis to reduce a dimension may be used.

Note that, regarding the taste sense, it is considered that a type, an amount, or the like of a taste sense chemical component are elements that affect an impression of a person. In addition, regarding the olfactory sense, it is considered that a type and a concentration of an olfactory sense chemical component are elements that affect an impression of a person. In addition, regarding the auditory sense, it is considered that a signal intensity, a power spectrum, or the like are elements that affect an impression of a person. Of course, regarding these parameters, a parameter and a value obtained by subjecting main component analysis or factor analysis to reduce a dimension may be used.

Note that, the value of the material parameter may be, for example, an actual measurement value obtained by any measurement method, or a value obtained by normalizing the values of the material parameters for all the materials. However, when the actual measurement value is used, it is necessary to unify the unit of the values of the material parameters for all the materials. For example, when the value of the average roughness Ra defined by the standard is used as the material parameter of “roughness”, the values of the material parameters of “roughness” for all the materials may be unified to a value in units of millimeter, micrometer, or the like.

Note that, in an impression received from a material used in industrial products such as a food packaging material, a house building material, and a synthetic leather for bag, it is considered that an impression due to the visual sense and the tactile sense which are specific in the five senses occupies a large specific gravity.

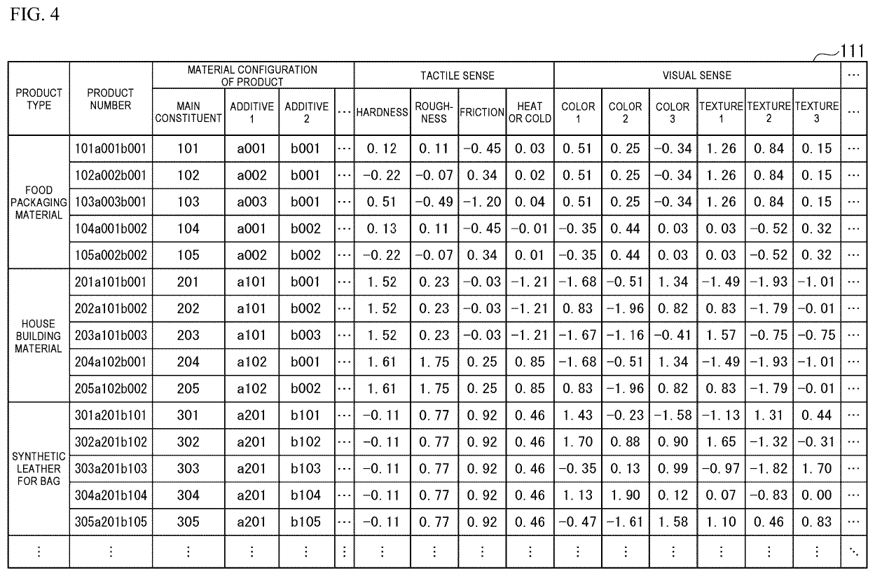

FIG. 4 is a diagram showing an example of the material parameter information 111 stored in the parameter information storage unit 110 of the material recommendation device 100 according to one or more embodiments of the disclosure. The material parameter information 111 is data indicating the association between the material and the above-described five sense parameter. Hereinafter, the five sense parameter associated with the material is referred to as a “material parameter”.

In the material parameter information 111 shown in FIG. 4, a product type, a product number, information indicating a material configuration of a product, and a material parameter are associated with one another. Each row of the material parameter information 111 is information related to one material.

For example, in the first row of the material parameter information 111 shown in FIG. 4, a value of “food packaging material” is registered in the item “product type”, and a value of “101a001b001” is set in the item “product number”. This indicates that the material with the product number “101a001b001” is a material used for the food packaging material. In addition, in the first row of the material parameter information 111 shown in FIG. 4, a value of “101” is set in an item “main constituent” of the item “material configuration of a product”, a value of “a001” is set in an item “additive 1”, and a value of “b001” is set in an item “additive 2”. This indicates that the material with the product number “101a001b001” is a material containing a main constituent with identification information “101”, an additive with identification information “a001”, an additive with identification information “b001”, or the like.

In addition, for example, a value standardized based on 0 is registered in each material parameter of the material parameter information 111. The standardization is an operation in which a value of each material parameter is divided by a standard deviation by subtracting an average value of the entire database of each material parameter, and the average is 0 and the variance is 1 as the standard deviation. Thus, each material is quantified by the five sense parameter (material parameter). According to the example of FIG. 4, the value of the five sense parameter “hardness” of the product number “101a001b001” is “0.12”, and the value of the five sense parameter “heat or cold” is “0.03”.

Note that, depending on the product type, there are some materials whose impressions are not affected by some senses (for example, auditory sense and taste sense) among the five senses. For example, the taste sense may slightly affect the impression on the food packaging material, but does not affect the impression on the house building material and the synthetic leather for bag.

The emotion word parameter extraction unit 132 acquires the emotion word output from the emotion word input unit 122. As an example is shown in FIG. 2, an information word is a phrase representing an emotion of a person. In addition, the emotion word parameter extraction unit 132 refers to the emotion word parameter information 112 stored in the parameter information storage unit 110. The emotion word parameter extraction unit 132 extracts, from the emotion word parameter information 112, a value of an emotion word parameter associated with the acquired emotion word.

The emotion word parameter information 112 is information indicating a degree of association between the emotion word and the five sense parameter. In addition, as described above, the five sense parameter referred to here is implemented by an item indicating senses obtained by further subdividing each of the five senses as shown in FIG. 3, for example.

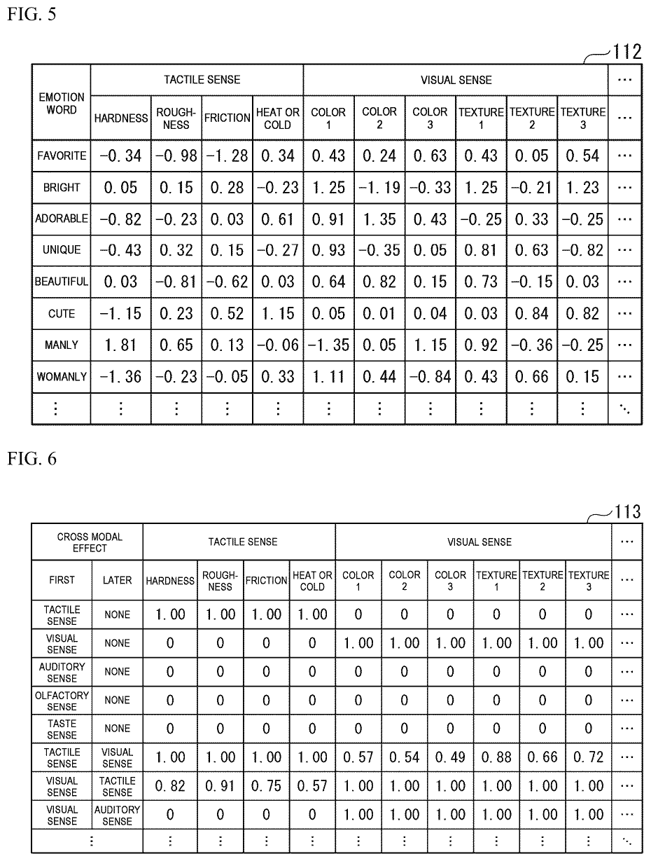

FIG. 5 is a diagram showing an example of the emotion word parameter information 112 stored in the parameter information storage unit 110 of the material recommendation device 100 according to one or more embodiments of the disclosure. The emotion word parameter information 112 is data indicating the association between the emotion word and the above-described five sense parameter. Hereinafter, the five sense parameter associated with the emotion word is referred to as an “emotion word parameter”.

In the emotion word parameter information 112 shown in FIG. 5, the emotion word and the emotion word parameter are associated with each other. Each row of the emotion word parameter information 112 is information related to one emotion word. According to the example of FIG. 5, in the emotion word “beautiful”, a value of the five sense parameter “texture 1” is “0.73”, and a value of the five sense parameter “texture 2” is “−0.15”.

Thus, each emotion word is quantified in advance by the five sense parameter (the emotion word parameter). Note that, as the method for quantify, for example, a method is conceivable in which a sensory evaluation using an emotion word is performed on each material in advance for a plurality of subjects, and a regression model of the emotion word and the five sense parameter is created to determine a numerical value. In addition, standardized values using the entire emotion word database may be used as the emotion word parameters, similarly to the material parameter.

A value standardized based on 0 is registered in each emotion word parameter of the emotion word parameter information 112, similarly to the value of the material parameter shown in FIG. 4. The standardization is an operation in which a value of each emotion word parameter is divided by a standard deviation by subtracting an average value of the entire database of each emotion word parameter, and the average is 0 and the variance is 1 as the standard deviation. Thus, each emotion word is quantified by the five sense parameter (the emotion word parameter).

The modal correction unit 133 acquires the use state information output from the use state input unit 123. As described above, the use state information is information that can identify a state in which, how the user receives an impression according to which sense among the five senses. In addition, the modal correction unit 133 refers to the modal correction information 113 stored in the parameter information storage unit 110. The modal correction unit 133 corrects, based on the acquired use state information and the modal correction information 113, the value of the material parameter extracted by the material parameter extraction unit 131 and the value of the emotion word parameter extracted by the emotion word parameter extraction unit 132.

Specifically, for example, the modal correction unit 133 identifies, based on the use state information, a state in which, what order the user depends to receive impressions by senses when receiving the impressions by a plurality of senses of the five senses. The modal correction unit 133 extracts, from the modal correction information 113, a coefficient group for considering the cross modal effect occurring in the identified use state. The modal correction unit 133 multiplies the extracted coefficient group by the value of the material parameter extracted by the material parameter extraction unit 131 and the value of the emotion word parameter extracted by the emotion word parameter extraction unit 132.

In general, the cross modal effect refers to a mutual relationship between impressions of two senses among the five senses, such as the visual sense and the tactile sense. In addition, in general, a multi modal effect refers to a mutual relationship among impressions by a plurality of types of senses among the five senses, such as the visual sense, the tactile sense, and the auditory sense. However, the cross modal effect in one or more embodiments includes the meaning of the multi modal effect.

For example, when a user recognizes a bag, the user may look at the bag carefully with their eyes and then touch the bag to check the feel of the bag, while conversely, the user may touch the bag to check the feel of the bag and then look at the bag carefully with their eyes. Then, depending on the sense of the visual sense and the tactile sense by which the user first receives the impression, a comprehensive impression that the user receives from the material differs. For example, a material such as a synthetic leather for bag generates a cross modal effect of giving the user a different impression depending on the order in which a plurality of senses act.

The material recommendation device 100 according to one or more embodiments takes the cross modal effect into consideration according to the use state based on the acquired use state information. Specifically, as described above, the modal correction unit 133 multiplies the coefficient group for considering the cross modal effect by the value of the material parameter extracted by the material parameter extraction unit 131 and the value of the emotion word parameter extracted by the emotion word parameter extraction unit 132. Accordingly, the value of the material parameter and the value of the emotion word parameter are corrected to values reflecting the affection of the cross modal effect according to the use state information.

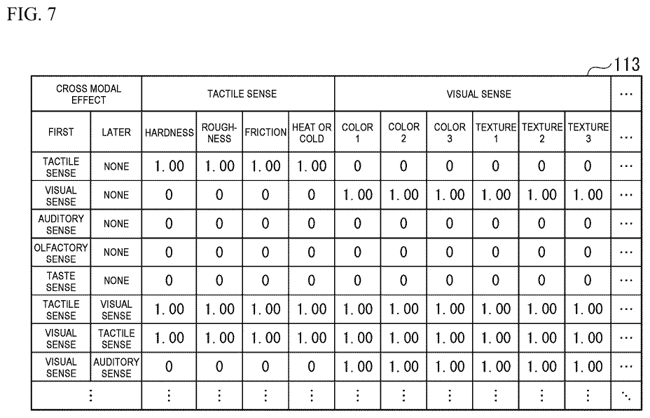

Note that, in one or more embodiments, the modal correction information 113 (for example, the modal correction information 113 shown in FIG. 6) including the coefficient group multiplied by the value of the material parameter and the modal correction information 113 (for example, the modal correction information 113 shown in FIG. 7) including the coefficient group multiplied by the value of the emotion word parameter are separately stored in the parameter information storage unit 110 in advance.

FIGS. 6 and 7 are diagrams showing an example of the modal correction information 113 stored in the parameter information storage unit 110 of the material recommendation device 100 according to one or more embodiments of the disclosure.

FIG. 6 shows an example of the modal correction information 113 including the coefficient group multiplied by the value of the material parameter. FIG. 6 represents a coefficient group corresponding to each piece of the use state information used for correcting the value of the material parameter. As shown in FIG. 6, in the case of the coefficient multiplied by the value of the material parameter, for example, 1 is set in advance as a coefficient value of a sense received first in the cross modal, a numerical value larger than 0 and smaller than 1 is set in advance as a coefficient value of a sense received later, and 0 is set in advance as a coefficient value of the other sense.

Note that, as a method for quantifying a coefficient, similarly to the case of quantifying the above-described emotion word in advance by the five sense parameter, for example, a method for determining a numerical value by performing a sensory evaluation in advance using each material for each use state on a plurality of subjects and creating a regression model of the use state and the material is considered.

FIG. 7 shows an example of the modal correction information 113 including the coefficient group multiplied by the value of the emotion word parameter. FIG. 7 represents a coefficient group corresponding to each piece of the use state information used for correcting the value of the emotion word parameter. As shown in FIG. 7, in the case of the coefficient multiplied by the value of the emotion word parameter, for example, 1 is set in advance as a coefficient value of a sense that causes the cross modal effect, and 0 is set in advance as a coefficient value of the other sense.

The material parameter extraction unit 131 outputs, to the recommendation material determination unit 134, the information indicating the material parameter corrected by the modal correction unit 133. In addition, the emotion word parameter extraction unit 132 outputs, to the recommendation material determination unit 134, the information indicating the emotion word parameter corrected by the modal correction unit 133.

The recommendation material determination unit 134 acquires the information indicating the material parameter output from the material parameter extraction unit 131 and the information indicating the emotion word parameter output from the emotion word parameter extraction unit 132. The recommendation material determination unit 134 calculates, for each material, a distance between coordinates of the value of the material parameter and the value of the emotion word parameter based on the acquired information. The recommendation material determination unit 134 determines a material to be recommended based on the calculated distance. For example, the recommendation material determination unit 134 determines, as the recommended material, a material having the shortest calculated distance or a predetermined number of materials in ascending order of the calculated distance.

The recommendation material determination unit 134 outputs information indicating the recommended material to the output unit 140. Note that, the recommendation material determination unit 134 may also output information indicating the distance between the value of the material parameter and the value of the emotion word parameter for each recommended material.

Note that, here, a method for simply comparing the distance between the value of the material parameter and the value of the emotion parameter is used in order to select a material matching the emotion word, and as another method, a method for solving an inverse problem such as Bayesian optimization may be used, or a method for solving a forward problem of minimizing an error by performing a grid search may be used. Note that, it is also possible to use automated machine learning (Auto ML) such as Data Robot (registered trademark) to perform the above-described work instead.

The output unit 140 is implemented using an output device that presents information to the user. The output device referred to here is, a display device, for example, a liquid crystal display (LCD), a cathode ray tube (CRT), or an organic electro-luminescence (EL) display. Note that, the output unit 140 may be a communication interface or the like that transmits information to an external device that presents the information to the user. Examples of the external device include an information processing device such as a general-purpose computer, various displays, or a printer.

The output unit 140 acquires the information, which indicates the recommended material and is output from the recommendation material determination unit 134. The output unit 140 presents the information indicating the recommended material to the user.

### Operation of Material Recommendation Device

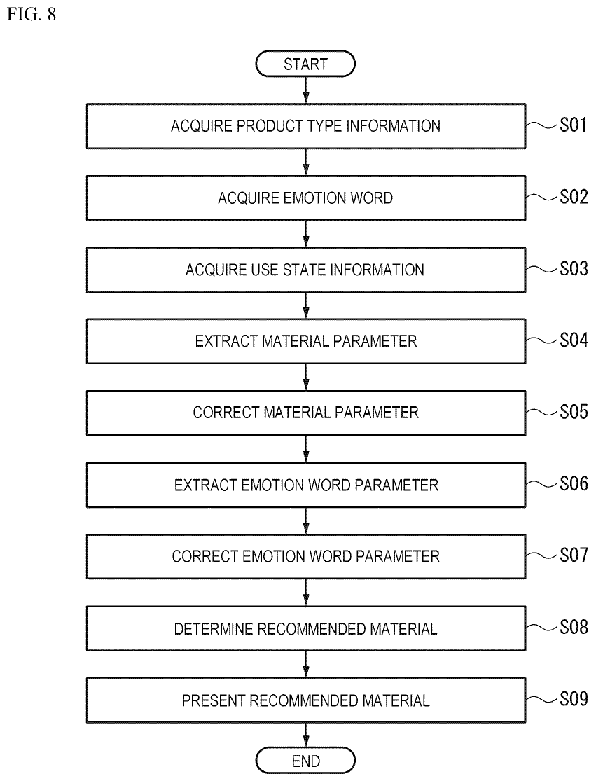

Hereinafter, an example of an operation of the material recommendation device 100 according to the disclosure will be described with a specific example. FIG. 8 is a flowchart showing the operation of the material recommendation device 100 according to one or more embodiments of the disclosure.

First, the product type input unit 121 receives an input of product type information by the user. For example, a list (“food packaging material”, “house building material”, “synthetic leather for bag”, . . . ) of values for the item “product type” in the leftmost column of the material parameter information 111 shown in FIG. 4 is displayed on a display device such as a display. The user performs an input operation of selecting a desired product type from the displayed list using an input device such as a mouse. Note that, here, as an example, it is assumed that the user selects the product type of “synthetic leather for bag”.

The product type input unit 121 outputs, to the material parameter extraction unit 131, the product type information indicating “synthetic leather for bag”. The material parameter extraction unit 131 acquires the product type information output from the product type input unit 121 (step S01).

Next, the emotion word input unit 122 receives an input of an emotion word by the user. For example, a list (“favorite”, “bright”, “adorable”, . . . ) of emotion words shown in FIG. 2 is displayed on a display device such as a display. The user performs an input operation of selecting a desired emotion word from the displayed list using an input device such as a mouse. Note that, here, as an example, it is assumed that the user selects an emotion word “beautiful”. Note that, the invention is not limited to this example, and a plurality of emotion words may be selected. In this case, the following processing is executed for each emotion word.

The emotion word input unit 122 outputs an emotion word “beautiful” to the emotion word parameter extraction unit 132. The emotion word parameter extraction unit 132 acquires the emotion word output from the emotion word input unit 122 (step S02).

Next, the use state input unit 123 receives an input of use state information by the user. For example, a list (“tactile sense” and “none”, “visual sense” and “none”, “auditory sense” and “none,” . . . ) of values for items “first” and “later” of the “cross modal effect,” which is the first to second columns from the left side of the modal correction information 113 shown in FIG. 6 or FIG. 7, is displayed on a display device such as a display. The user assumes a use state when the user uses the product and performs an input operation of selecting desired use state information from the displayed list by using an input device such as a mouse. Note that, here, as an example, it is assumed that the user selects use state information in which the sense received first is the “visual sense” and the sense received later is the “tactile sense”.

The use state input unit 123 outputs, to the modal correction unit 133, the use state information indicating that the sense received first is the “visual sense” and the sense received later is the “tactile sense”. The modal correction unit 133 acquires the use state information output from the use state input unit 123 (step S03).

Note that, for example, a list of options including words such as “determine whether to purchase only by looking at a bag” and “determine whether to purchase by confirming a touching comfort after looking at a bag” may be displayed on a display device such as a display, and the user may select from the list. In this case, for example, the parameter information storage unit 110 stores in advance information in which the options are associated with one or more senses. That is, for example, the information, in which “determine whether to purchase only by looking at a bag” is associated with the “visual sense” and “determine whether to purchase by checking a touching comfort after looking at a bag” is associated with the “visual sense” and the “tactile sense”, is stored in advance.

Then, for example, when the modal correction unit 133 acquires, from the use state input unit 123, the information indicating that an option, such as “determine whether to purchase by checking a touching comfort after looking at a bag”, is selected by the user, the modal correction unit 133 can identify that the use state information, in which the sense received first is the “visual sense” and the sense received later is the “tactile sense”, is selected by referring to the above-described information stored in the parameter information storage unit 110 in advance.

Next, the material parameter extraction unit 131 extracts the value of the material parameter associated with the product type corresponding to the acquired product type information from the material parameter information 111 stored in advance in the parameter information storage unit 110 (step S04). For example, here, since the product type of “synthetic leather for bag” is selected by the user, the material parameter extraction unit 131 extracts all data (values of material parameters) of a row in which the value of the item “product type” in the material parameter information 111 shown in FIG. 4 is “synthetic leather for bag”.

Note that, in the material parameter information 111 shown in FIG. 4, the number of rows, in which the value of the item “product type” is “synthetic leather for bag”, is five (m=5). That is, a total of five materials used as the material of the synthetic leather for bag are registered (product numbers “301a201b101” to “305a201b105”). When the number of material parameters (sense parameters) associated with each material is n, the material parameter extraction unit 131 extracts m (five) matrices (hereinafter, referred to as “matrix A”) each having one row and n columns.

Next, the modal correction unit 133 corrects, based on the acquired use state information and the modal correction information 113, the value of the material parameter extracted by the material parameter extraction unit 131 (step S05).

For example, here, the use state information, in which the sense received first is the “visual sense” and the sense received later is the “tactile sense”, is selected by the user. Therefore, the modal correction unit 133 extracts data (coefficient group) of a row in which the value of the item “first” of the item “cross modal effect” in the modal correction information 113 shown in FIG. 6 is the “visual sense” and the value of the item “later” is the “tactile sense”. When the number of material parameters associated with each material is n, the modal correction unit 133 extracts one matrix having one row and n columns. Then, the modal correction unit 133 generates a diagonal matrix (hereinafter referred to as “diagonal matrix B”) having n rows and n columns with the extracted matrix as diagonal components.

The modal correction unit 133 corrects the value of the material parameter by multiplying each of the extracted matrices A by the generated diagonal matrix B. Accordingly, the value of the material parameter is corrected to a value in consideration of the cross modal effect according to the selected use state information.

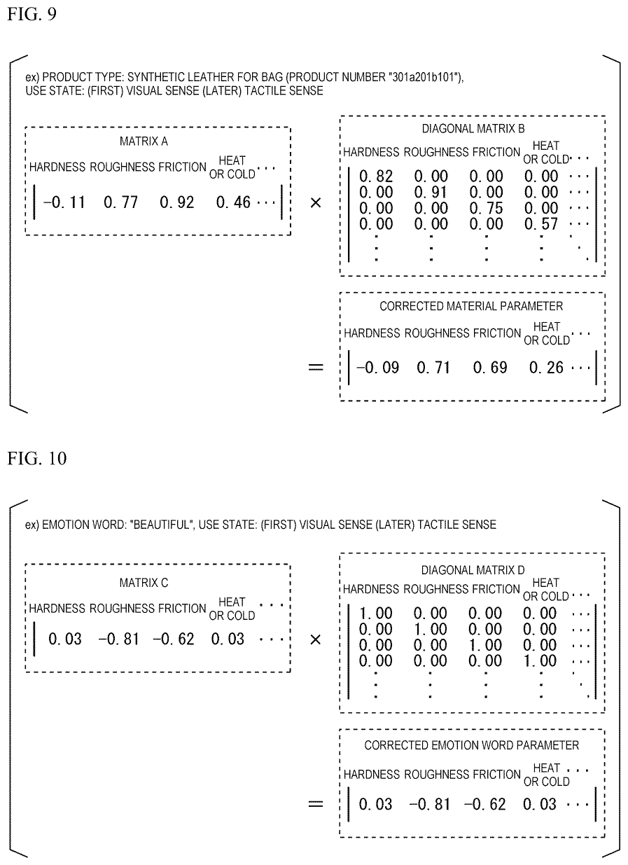

FIG. 9 is a diagram showing an example of correction processing of the value of the material parameter performed by a modal correction unit 133 of the material recommendation device 100 according to one or more embodiments of the disclosure. In FIG. 9, as an example, matrix calculation for correcting the value of the material parameter of the synthetic leather for bag to which the product number “301a201b101” is given is shown. As shown in FIG. 9, by multiplying the matrix A composed of the values of the material parameters extracted from the material parameter information 111 shown in FIG. 4 by the diagonal matrix B generated from the coefficient group extracted from the modal correction information 113 shown in FIG. 6, a matrix composed of the corrected values of the material parameters is calculated (“−0.09”, “0.71”, “0.69”, “0.26”, . . . ).

Next, the emotion word parameter extraction unit 132 extracts the value of the emotion word parameter associated with the acquired emotion word from the emotion word parameter information 112 stored in advance in the parameter information storage unit 110 (step S06). For example, here, since the emotion word “beautiful” is selected by the user, the emotion word parameter extraction unit 132 extracts the data (the value of the emotion word parameter) of the row in which the value of the item “emotion word” in the emotion word parameter information 112 shown in FIG. 5 is “beautiful”.

When the number of emotion word parameters (sense parameters) associated with each emotion word is n, the emotion word parameter extraction unit 132 extracts m matrices (hereinafter referred to as “matrix C”) each having one row and n columns. Note that, the value of m referred to here represents the number of emotion words selected by the user. Note that, here, as an example, since only one emotion word (“beautiful”) is selected by the user, the emotion word parameter extraction unit 132 extracts one matrix C.

Next, the modal correction unit 133 corrects, based on the acquired use state information and the modal correction information 113, the value of the emotion word parameter extracted by the emotion word parameter extraction unit 132 (step S07).

For example, here, the use state information, in which the sense received first is the “visual sense” and the sense received later is the “tactile sense”, is selected by the user. Therefore, the modal correction unit 133 extracts data (coefficient group) of a row in which the value of the item “first” of the item “cross modal effect” in the modal correction information 113 shown in FIG. 7 is the “visual sense” and the value of the item “later” is the “tactile sense”. When the number of emotion word parameters associated with each emotion word is n, the modal correction unit 133 extracts one matrix having one row and n columns. Then, the modal correction unit 133 generates a diagonal matrix (hereinafter referred to as “diagonal matrix D”) having n rows and n columns with the extracted matrix as diagonal components.

The modal correction unit 133 corrects the value of the emotion word parameter by multiplying each (here, one) of the extracted matrices C by the generated diagonal matrix D. Thus, the value of the emotion word parameter is corrected to a value in consideration of the cross modal effect.

FIG. 10 is a diagram showing an example of correction processing of the value of the emotion word parameter performed by the modal correction unit 133 of the material recommendation device 100 according to one or more embodiments of the disclosure. FIG. 10 shows matrix calculation for correcting the value of the emotion word parameter corresponding to the emotion word “beautiful”. As shown in FIG. 10, by multiplying the matrix C composed of the values of the emotion word parameters extracted from the material parameter information 111 shown in FIG. 5 by the diagonal matrix D generated from the coefficient group extracted from the modal correction information 113 shown in FIG. 7, a matrix composed of the corrected values of the emotion word parameters is calculated (“0.03”, “−0.81”, “−0.62”, “0.03”, . . . ) .

The material parameter extraction unit 131 outputs the corrected value of the material parameter to the recommendation material determination unit 134. In addition, the emotion word parameter extraction unit 132 outputs the corrected value of the emotion word parameter to the recommendation material determination unit 134.

Next, the recommendation material determination unit 134 acquires the corrected value of the material parameter output from the material parameter extraction unit 131 and the corrected value of the emotion word parameter output from the emotion word parameter extraction unit 132. The recommendation material determination unit 134 recognizes the acquired matrix of the material parameters and the acquired matrix of the emotion word parameters as coordinates, and calculates a distance between the coordinates for each material. The recommendation material determination unit 134 determines a material to be recommended based on the calculated distance (step S08). For example, from among a plurality of materials, a material having a close distance between a coordinate of an emotion word parameter corresponding to an emotion word designated by the user and a coordinate of a material parameter corresponding to the material is considered to have a strong relationship with the emotion word, and can be identified in order.

FIG. 11 is a diagram showing an example of calculation processing of a distance between coordinates performed by the recommendation material determination unit 134 of the material recommendation device 100 according to one or more embodiments of the disclosure. FIG. 11 shows processing of calculating the distance between the coordinates by subtracting the components of the matrix, which is composed of the values of the material parameters after correction calculated by the correction processing shown in FIG. 9, from the matrix composed of the values of the emotion word parameters after correction calculated by the correction processing shown in FIG. 10, squaring each value of the calculated components of the matrix, and further adding up the calculated values to calculate a route.

For example, in FIG. 11, since the value of the emotion word parameter of “hardness” is “0.03” and the value of the material parameter of “hardness” is “−0.09”, “0.0144” is obtained by performing subtraction and squaring on the values. The recommendation material determination unit 134 adds up the component values calculated for each five sense parameter in this manner, and further calculates the route to set the calculated value as the distance between the coordinates of the emotion word parameter and the material parameter. Note that, here, it is assumed that the calculated distance between the coordinates is, for example, a square root of “4.0938+α”. However, the calculation for the distance between the coordinates is not limited to this example, and the distance may be calculated by another method known in the technical field.

The recommendation material determination unit 134 performs the above calculation for each material and each emotion word to calculate a distance between coordinates. The recommendation material determination unit 134 determines a material to be recommended based on the calculated distance between the coordinates. The recommendation material determination unit 134 outputs, to the output unit 140, information indicating the recommended material and information indicating the distance between the coordinates calculated for the material.

The output unit 140 acquires the information indicating the recommended material output from the recommendation material determination unit and the information indicating the distance between the coordinates calculated for the material. The output unit 140 presents, to the user, the information indicating the recommended material and the information indicating the distance between the coordinates calculated for the material (step S09).

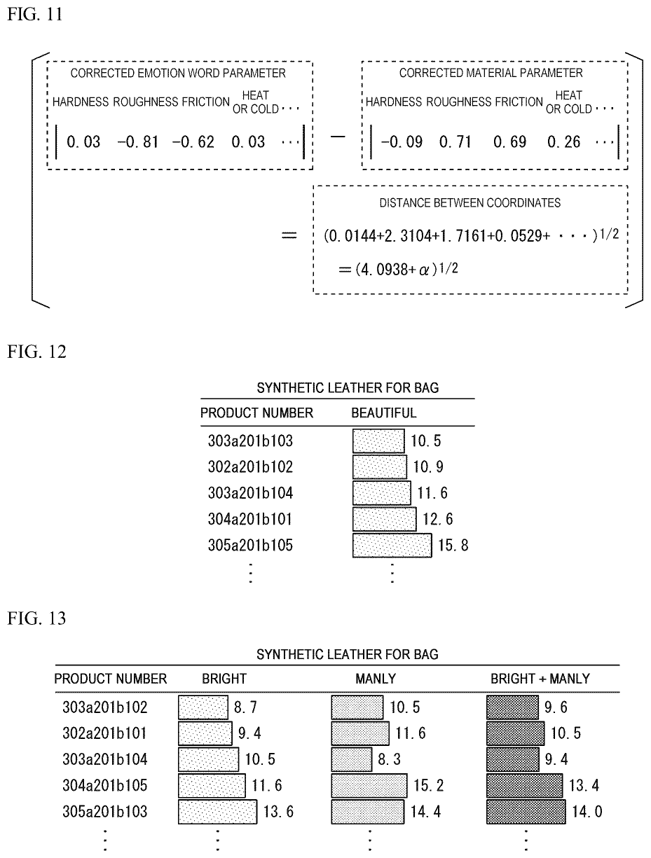

FIG. 12 is a diagram showing an example of information output by the output unit 140 of the material recommendation device 100 according to one or more embodiments of the disclosure. As shown in FIG. 12, the information output by the output unit 140 includes, for example, a selected product type (“synthetic leather for bag”), a selected emotion word (“beautiful”), and a value of a distance between coordinates for each material (for each product number). At this time, the output unit 140 outputs the materials in ascending order of the distance between the coordinates, so that the more recommended material is displayed at a higher rank. Note that, as shown in FIG. 12, since the distance between the coordinates is also displayed in a bar graph, the user can more intuitively recognize a recommendation degree of each material. However, the invention is not limited to this example, and the distance between the coordinates may be displayed in a predetermined order of the product number.

Note that, an example of a method for presenting a recommended material by the output unit 140 when the user selects a plurality of emotion words will be described below. FIG. 13 is a diagram showing another example of the information output by the output unit 140 of the material recommendation device 100 according to one or more embodiments of the disclosure. Here, it is assumed that the user selects an emotion word “bright” and an emotion word “manly”.

In the example of FIG. 13, the information output by the output unit 140 includes, for example, a selected product type (“synthetic leather for bag”). In addition, the information output by the output unit 140 includes, for example, a value of a distance between coordinates for each material (for each product number) for each selected emotion word (“bright” and “manly”). Further, the information output by the output unit 140 includes, for example, an average value of distances between coordinates in the plurality of emotion words for each material.

Since the information is presented by the output unit 140 in this manner, the user can recognize that, for example, a synthetic leather for bag closest to an impression of “bright” is a material to which a product number “303a201b102” having a distance of “8.7” between coordinates is given. In addition, the user can recognize that, for example, a synthetic leather for bag closest to an impression of “manly” is a material to which a product number “303a201b104” having a distance of “8.3” between coordinates is given. In addition, the user can recognize that, for example, a synthetic leather for bag that highly has an impression of “bright” and an impression of “manly” on average is a material to which a product number “303a201b104” having a distance of “9.4” between coordinates is given. When three or more emotion words are designated, an average value of the three emotion words may be output, or an average value may be output for each combination of two among the three emotion words.

Accordingly, for example, the user can select a material having the shortest distance among all the coordinates, or can select a material having an impression closest to the plurality of selected emotion words on average.

Note that, for example, the output unit 140 may generate and present a map that can visually grasp the coordinate of the material parameter and the coordinate of the emotion word parameter. In addition, for example, the output unit 140 may perform main component analysis or analysis by multi-dimensional scaling on the coordinate of the material parameter and the coordinate of the emotion word parameter, and visually present the analysis result. For example, in the case of the main component analysis, the output unit 140 may present a positional relationship between the coordinates of the material parameter and the emotion word parameter by two axes of a first main component and a second main component in a two-dimensional diagram based on BiPlot.

As described above, the material recommendation device 100 according to one or more embodiments of the disclosure includes the input unit 120, the material parameter extraction unit 131, the emotion word parameter extraction unit 132, and the recommendation material determination unit 134. The input unit 120 receives an input of information that indicates a product type and an emotion word indicating a word expressing an emotion. The material parameter extraction unit 131 extracts, based on material parameter information in which a material used for a product belonging to a product type is associated with a value of a sense parameter indicating a degree of sense of a person for the material, a value of a sense parameter (material parameter) for each material corresponding to the product type input to the input unit 120. The emotion word parameter extraction unit 132 extracts, based on emotion word parameter information in which an emotion word is associated with a value of a sense parameter, a value of a sense parameter (emotion word parameter) corresponding to the emotion word input to the input unit 120. The recommendation material determination unit 134 determines, based on the value of the sense parameter for each material extracted by the material parameter extraction unit 131 and the value of the sense parameter extracted by the emotion word parameter extraction unit 132, a material to be recommended for the emotion word input to the input unit 120.

With such a configuration, for example, the material recommendation device 100 can automatically recommend an appropriate material according to an emotion of a person without depending on a sense or the like of a specific person in charge who recommends a material.

In addition, the material recommendation device 100 corrects the value of the sense parameter for each material and the value of the sense parameter corresponding to the emotion word in consideration of an affection of the cross modal effect. With such a configuration, the material recommendation device 100 can recommend an appropriate material with higher accuracy according to an emotion of a person.

### Modification

Among the functional configurations of the material recommendation device 100 shown in FIG. 1, the modal correction information 113, the use state input unit 123, and the modal correction unit 133 may be omitted to provide a simpler configuration. That is, among the functions of the material recommendation device 100, a material recommendation device, in which a configuration for correcting five sense parameters in consideration of a cross modal effect is omitted, may be used. The material recommendation device 100 may determine a material to be recommended without correcting a value of a sense parameter for each material and a value of a sense parameter according to use state information. Thus, with a simpler configuration, it is possible to reduce a device cost and an operation cost of the material recommendation device 100, the number of steps for preparing the modal correction information 113, or the like.

Note that, the above-described processing may be performed by recording instructions for implementing the function of the material recommendation device 100 according to one or more embodiments in a computer-readable recording medium and causing a computer system to read and execute the instructions recorded in the recording medium. Note that, the “computer system” referred to here includes an OS and hardware such as a peripheral device. In addition, the “computer system” includes a WWW system having a home page providing environment (or a display environment). In addition, the “computer-readable recording medium” refers to a portable medium such as a flexible disk, a magneto-optical disk, a ROM, or a CD-ROM, or a storage device such as a hard disk incorporated in a computer system. Further, the “computer-readable recording medium” includes a medium that holds the instructions for a certain period of time, such as a volatile memory (RAM) in a computer system serving as a server or a client when the instructions are transmitted via a network such as the Internet or a communication line such as a telephone line.

In addition, the instructions may be transmitted from a computer system, in which the instructions are stored in a storage device or the like, to another computer system via a transmission medium or through a transmission wave in the transmission medium. Here, the “transmission medium” that transmits the instructions refers to a medium having a function of transmitting information, such as a network (communication network) such as the Internet or a communication line (communication wire) such as a telephone line. In addition, the instructions may be a program for implementing a part of the above-described functions. Further, the instructions may be a so-called difference file (difference program) capable of implementing the above-described functions in combination with the instructions already recorded in the computer system.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

100: material recommendation device
110: parameter information storage unit
111: material parameter information
112: emotion word parameter information
113: modal correction information
120: input unit
121: product type input unit
122: emotion word input unit
123: use state input unit
131: material parameter extraction unit
132: emotion word parameter extraction unit
133: modal correction unit
134: recommendation material determination unit
140: output unit

1. A material recommendation device, comprising:
an input device that receives an input of a product type and an emotion word expressing an emotion of a user; and
a hardware processor that:
extracts, based on material parameter information that associates a material used in a product belonging to the product type with a value of a sense parameter indicating a degree of a human sense for the material, a value of a sense parameter for each material corresponding to the product type input to the input device;
an emotion extracts, based on emotion word parameter information that associates the emotion word with the value of the sense parameter, a value of a sense parameter corresponding to the emotion word input to the input device; and
identifies, based on the value of the sense parameter for each material that has been extracted and the value of the sense parameter corresponding to the emotion word that has been extracted, the material to be recommended for the emotion word input to the input device, and presents the material that has been identified to the user.

2. The material recommendation device according to claim 1, wherein
the emotion word is a phrase classified into an evaluation factor or an activity factor among factors of an evaluation-potency-activity (EPA) structure defined in an impression evaluation according to a semantic differential (SD) method.

3. The material recommendation device according to claim 1, wherein
the hardware processor corrects the value of the sense parameter using a coefficient in consideration of a cross modal effect in which impressions received by a plurality of types of senses are related to each other.

4. The material recommendation device according to claim 3, wherein
the coefficient is set to a value that is different according to an order in which the impressions are received by the types of senses, and
the hardware processor acquires information indicating the order and corrects the value using the coefficient corresponding to the acquired order.

5. The material recommendation device according to claim 4, wherein
the coefficient used for correcting the value of the sense parameter for each material is set to a value of 1 for the sense received first, is set to a value larger than 0 and smaller than 1 for the sense received later, and is set to 0 for other senses.

6. The material recommendation device according to claim 4, wherein
the coefficient used for correcting the value of the sense parameter corresponding to the emotion word is set to a value of 1 for the sense in which the cross modal effect occurs, and is set to a value of 0 for the sense in which the cross modal effect does not occur.

7. The material recommendation device according to claim 1, wherein
the sense includes five senses or a sense obtained by subdividing the five senses.

8. A material recommendation method for a material recommendation device comprising an input device, the method comprising:
receiving, by the input device, an input of a product type and an emotion word expressing an emotion of a user;
extracting, based on material parameter information that associates a material used in a product belonging to the product type with a value of a sense parameter indicating a degree of a human sense for the material, a value of a sense parameter for each material corresponding to the product type input to the input device;
extracting, based on emotion word parameter information that associates the emotion word with the value of the sense parameter, a value of a sense parameter corresponding to the emotion word input to the input device; and
a identifying, based on the value of the sense parameter for each material that has been extracted and the value of the sense parameter corresponding to the emotion word that has been extracted, the material to be recommended for the emotion word input to the input device, and presenting the material that has been identified to the user.

9. A non-transitory computer-readable recording medium storing instructions for causing a material recommendation device comprising an input device to execute:
receiving, by the input device, an input of a product type and an emotion word expressing an emotion of a user;
extracting, based on material parameter information that associates a material used in a product belonging to the product type with a value of a sense parameter indicating a degree of a human sense for the material, a value of a sense parameter for each material corresponding to the product type input to the input device;
extracting, based on emotion word parameter information that associates the emotion word with the value of the sense parameter, a value of a sense parameter corresponding to the emotion word input to the input device; and
a identifying, based on the value of the sense parameter for each material that has been extracted and the value of the sense parameter corresponding to the emotion word that has been extracted, the material to be recommended for the emotion word input to the input device, and presenting the material that has been identified to the user.
